(19) United States
(12) Patent Application Publication
(10) Pub. No.: US 2011/0082806 A1
(43) Pub. Date: Apr. 7, 2011

(54) PRODUCT SALE PROCESSING APPARATUS AND METHOD

(75) Inventor: Shigeru Komatsu, Shizuoka (JP)

(73) Assignee: TOSHIBA TEC KABUSHIKI KAISHA, Tokyo (JP)

(21) Appl. No.: 12/897,940

(22) Filed: Oct. 5, 2010

(30) Foreign Application Priority Data
Oct. 6, 2009 (JP) 2009-232740

(51) Int. Cl. G06Q 99/00

(52) U.S. Cl. 705/317

(57) ABSTRACT

According to an embodiment, a product sale processing apparatus includes an emission amount acquisition unit that acquires the amount of carbon-dioxide emission over the entire course from the procurement of the raw materials of products processed for sale to the disposal or recycling, and a notification unit that provides notification of the carbon-dioxide emission amount acquired by the emission amount acquisition unit.

### CROSS-REFERENCE TO RELATED APPLICATION

This application is based upon and claims the benefit of Japanese Patent Application No. 2009-232740 filed on Oct. 6, 2009; the entire contents of which are incorporated herein by reference.

### FIELD

Embodiments described herein relate generally to a product sale processing apparatus and method.

### BACKGROUND

Presently, global warming is an issue of concern. Society as a whole is focusing on environmental conservation based on carbon offsets and doing activities for environmental conservation. For example, under the current circumstances that both manufacturers who manufacture products and customers who purchase the products are highly conscious of environmental conservation, many attempts are made to urge the manufacturers to indicate the amount and the statistics regarding the emission of carbon dioxides in the course of manufacturing products so as to raise the level of consciousness regarding environmental conservation and suppress the amount of emission of carbon dioxides. Moreover, JP-A-2009-116843 discloses a scheme in which when a consumer uses an eco-friendly bag instead of a plastic bag, an incentive corresponding to the amount of reduction in the carbon-dioxide emission resulting from not using the plastic bag is imparted to the consumer.

In recent years, there are an increasing number of products on which the amount of carbon oxides emitted over the entire course from the procurement of the raw materials of the product to the disposal or recycling is printed with the carbon footprint. Therefore, on the momentum of rise in consciousness of environmental conservation of the manufacturers, there is a demand for raising the level of consciousness of the retailers regarding environmental conservation through a campaign for eco-friendly products by conducting a campaign for environmental conservation and calculating the statistics of the amount of carbon-dioxide emission of products using POS (Point Of Sales) systems that perform processing for the sales and inventory management of the products.

### BRIEF DESCRIPTION OF THE DRAWINGS

FIG. 1 is a schematic system configuration diagram showing an entire configuration of a POS system.

FIG. 2 is a front perspective view showing an outer appearance of a store system functioning as a POS terminal.

FIG. 3 is a block diagram showing an electrical connection of the store system.

FIG. 4 is a block diagram showing an electrical connection of a headquarters system.

FIG. 5 is a schematic diagram showing a file structure of a product file which is stored in a database and which each store system can access via the headquarters system.

FIG. 6 is a block diagram showing a module configuration of a store system according to the present embodiment.

FIG. 7 is a flowchart showing the flow of a process of providing notification of the amount of carbon-dioxide emission of a product processed for sale.

### DETAILED DESCRIPTION

According to an embodiment, a product sale processing apparatus includes an emission amount acquisition unit and a notification unit. The emission amount acquisition unit acquires the amount of carbon-dioxide emission over the entire course from the procurement of the raw materials of a product processed for sale to the disposal or recycling. The notification unit provides notification of the amount of carbon-dioxide emission acquired by the emission amount acquisition unit.

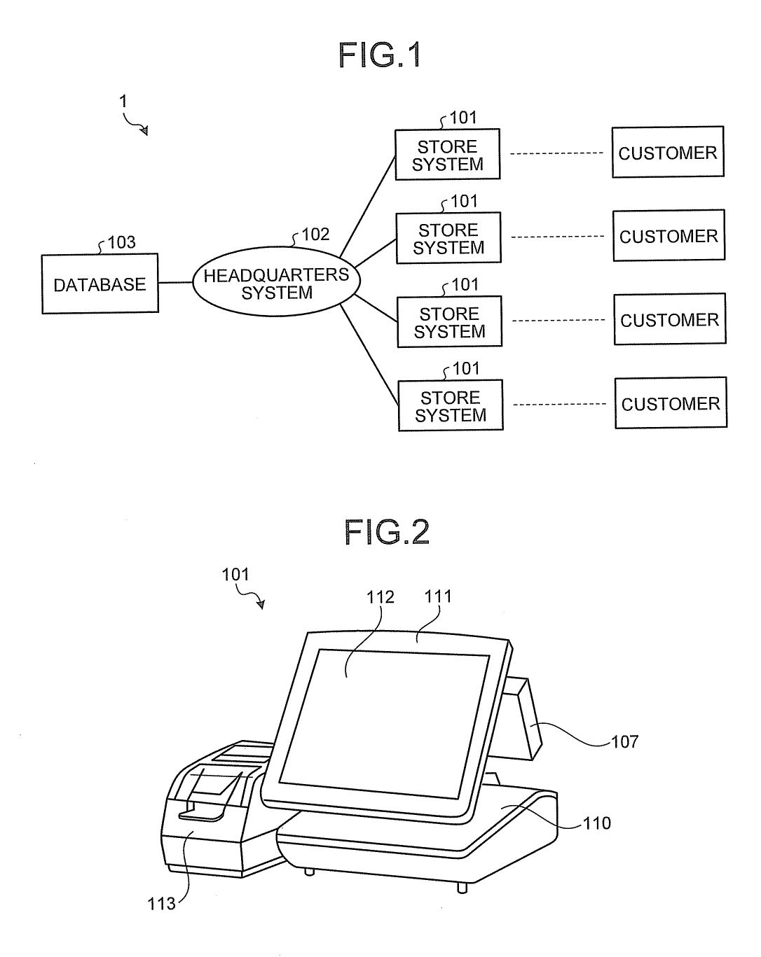

Hereinafter, the present embodiment will be described with reference to FIGS. 1 to 7. The present embodiment is an example in which a product sale processing apparatus and method according to the present embodiment is applied to a POS (Point Of Sales) terminal of a POS system that performs processing for the sales and inventory management of the product.

FIG. 1 is a schematic system configuration diagram showing an entire configuration of a POS system. A POS system 1 shown in FIG. 1 includes a store system 101 serving as a POS terminal that performs product sale processing to customers, a headquarters system 102 serving as a server that performs processing of the inventory management of a product and the overall control of the POS system 1, and a database 103 that stores various kinds of information concerning the sale processing and inventory management of the product.

FIG. 2 is a front perspective view showing an outer appearance of a store system functioning as a POS terminal. The store system 101 has a liquid crystal display 111 which is mounted on an upper surface of a main unit 110 as a display device. The liquid crystal display 111 has a touch panel 112 serving as an input device, which is arranged on the surface of the liquid crystal display 111. Moreover, the store system 101 includes a printer 113 for issuing receipts and sales statements, which is disposed near the main unit 110. The store system 101 includes the printer 113 which is connected to the main unit 110 through an interface such as a USB (Universal Serial Bus), for example. The store system 101 further includes a customer-side display 107 which is connected to the main unit 110 in addition to the printer 113. For example, the customer-side display 107 is a 7-segment LED (Light Emitting Diode) display. The store system 101 has the customer-side display 107 which is disposed on the upper surface of the main unit 110. Similarly to the printer 113, the store system 101 has the customer-side display 107 which is also connected to the main unit 110 via an interface such as a USB.

The store system 101 includes a card rewrite terminal (not shown) which rewrites a point recorded on a point card possessed by a customer and which is connected to the main unit 110 via an interface such as a USB, for example. Here, the point recorded on the point card is, for example, a point that is added in accordance with the price or the like of the product purchased by a customer.

Returning to FIG. 1, the headquarters system 102 includes a small-sized liquid crystal display 309 and a keyboard 310 (see FIG. 4) and performs processing for management of various kinds of information received from each store system 101 and transmission of various kinds of information to each store system 101.

The database 103 stores various kinds of information that the headquarters system 102 received from each store system 101 and various kinds of information that the headquarters system 102 transmits to each store system 101.

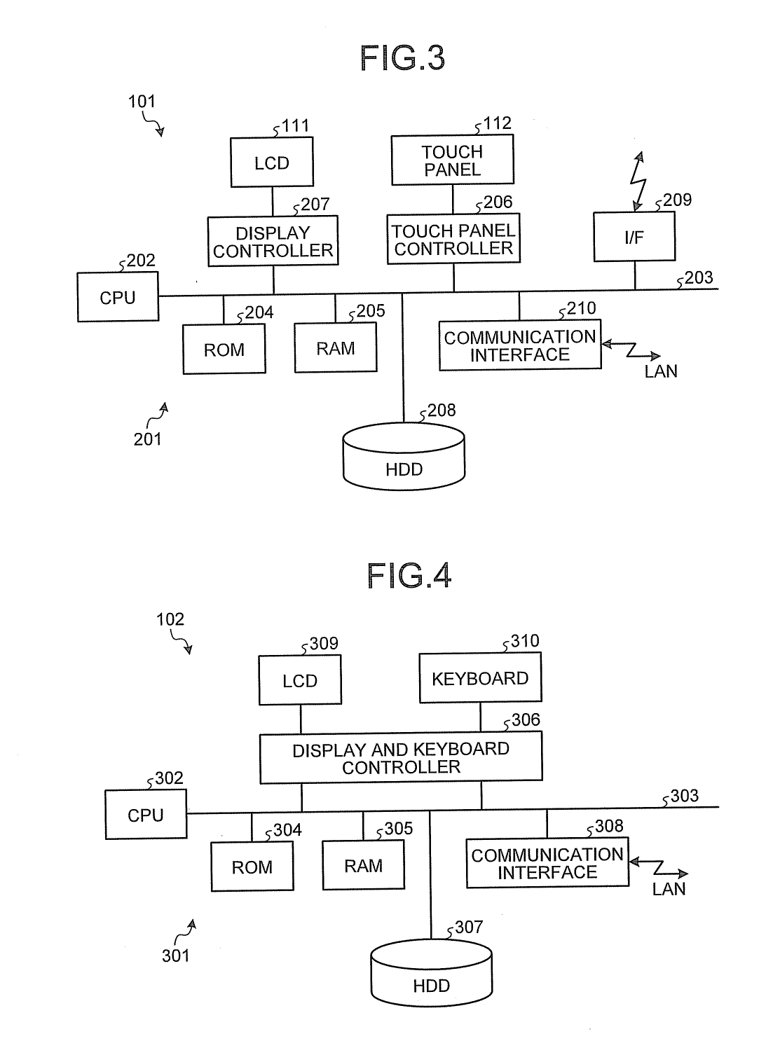

FIG. 3 is a block diagram showing an electrical connection of a store system. As shown in FIG. 3, the store system 101 includes a microcomputer 201. The microcomputer 201 drives and controls each unit of the store system 101. The microcomputer 201 includes a ROM (Read Only Memory) 204 and a RAM (Random Access Memory) 205 which are connected to a CPU (Central Processing Unit) 202 through a bus line 203. The CPU 202 controls an overall operation of each unit. The ROM 204 stores fixed information such as a control program in advance. The RAM 205 stores various kinds of information in a rewritable manner and functions as a work area or the like. Therefore, the microcomputer 201 constitutes an information processing unit that processes information.

Moreover, the microcomputer 201 connects a touch panel controller 206, a display controller 207, a HDD (Hard Disk Drive) 208, an interface 209, and a communication interface 210 to each other through the bus line 203. The touch panel controller 206 imports input signals from the touch panel 112 into the microcomputer 201. The display controller 207 drives and controls the liquid crystal display 111 based on image data and displays images corresponding to the image data on the liquid crystal display 111. The interface 209 is an interface for connecting the printer 113, the customer-side display 107, the card rewrite terminal (not shown), and the like to the microcomputer 201, and is a USB or the like as described above. The communication interface 210 is an interface for enabling the microcomputer 201 to perform data communication with other devices through a LAN (Local Area Network).

The store system 101 stores an OS (Operating System), a computer program, various kinds of files, and the like in the HDD 208. The CPU 202 accesses the OS, computer program, various kinds of files, and the like, the entireties or parts of which are copied from the HDD 208 into the RAM 205. The CPU 202 performs processing in accordance with the OS and computer program thus copied.

FIG. 4 is a block diagram showing an electrical connection of a headquarters system. As shown in FIG. 4, the headquarters system 102 includes a microcomputer 301. The microcomputer 301 drives and controls each unit of the headquarters system 102. The microcomputer 301 includes a ROM 304 and a RAM 305 which are connected to a CPU 302 through a bus line 303. The CPU 302 controls an overall operation of each unit. The ROM 304 stores fixed information such as a control program through the bus line 303 in advance. The RAM 305 stores various kinds of information in a rewritable manner and functions as a work area or the like. Therefore, the microcomputer 301 constitutes an information processing unit that processes information.

The headquarters system 102 connects a display and keyboard controller 306, a HDD 307, a communication interface 308 to the microcomputer 301 through the bus line 303. The display and keyboard controller 306 drives and controls the liquid crystal display 309 based on image data and displays images corresponding to the image data on the liquid crystal display 309. Moreover, the display and keyboard controller 306 imports input signals from the keyboard 310 into the microcomputer 301. The communication interface 308 is an interface for enabling the microcomputer 301 to perform data communication with other devices through a LAN.

The headquarters system 102 stores an OS, a computer program, various kinds of files, and the like in the HDD 307. The CPU 302 accesses the OS, computer program, various kinds of files, and the like, the entireties or parts of which are copied from the HDD 307 into the RAM 305. The CPU 302 performs processing in accordance with the OS and computer program thus copied.

FIG. 5 is a schematic diagram showing a file structure of a product file which is stored in a database and which each store system can access via the headquarters system. A store file 501 includes product information such as a product name 503, an emission amount 504, a point 505, a classification code 506, and a unit price (not shown), which are registered so as to correspond to a 2-digit code 502. For example, the code 502 is a code of a product sold in each store in which the store system 101 is provided and may be assigned as follows:

01: Detergent A

02: Detergent B

03: Detergent C

The product name 503 is a product name that is defined by the code registered in the code 502. The emission amount 504 is the amount of carbon-dioxide emission in the entire course including the procurement of the raw materials, production, use, and disposal or recycling of the product which is defined by the code registered in the code 502. The classification code 506 is a code for classifying products in the same category such as “Detergent” and “Copy Paper,” for example.

The point 505 is a point which is imparted as an incentive regarding environmental conservation corresponding to the amount of carbon-dioxide emission of the product defined by the code registered in the code 502, and which is added to the points recorded on a point card. More specifically, the point 505 is imparted in accordance with the amount of carbon-dioxide emission of a product, and a greater number of points are imparted to a product (eco-friendly product) of which the amount of carbon-dioxide emission is small. In the present embodiment, a point added to the point card of a customer who purchased detergent C of which the amount of carbon-dioxide emission is “20 g” is used as a reference which is “0 pt”, and the points added to the point cards of customers who purchased other detergents A and B are defined based on the reference point. For example, since the amount of carbon-dioxide emission of the detergent B, which is “10 g,” is smaller than the amount of carbon-dioxide emission of the detergent C, which is “20 g,” points worth “5 pt” are added to the point card of a customer who purchased the detergent B. Moreover, since the amount of carbon-dioxide emission of the detergent A, which is “5 g,” is smaller than the amount of carbon-dioxide emission of the detergent B, which is “10 g,” points worth “10 pt” are added to the point card of a customer who purchased the detergent A.

For example, the CPU 202 reads the codes 502 of products in the same category as the product processed for sale and the amounts of carbon-dioxide emission 504 corresponding to the codes 502 of the products in the same category as the product processed for sale from the product file 501 stored in the database 103. Subsequently, the CPU 202 rearranges the read codes 502 of the products in the descending order of the read amounts of carbon-dioxide emission 504. After that, the CPU 202 sets the points imparted to the sale processing of a product having the largest amount of carbon-dioxide emission 504 to “0 pt” and sets the points imparted to the sale processing of a product having the smallest amount of carbon-dioxide emission 504 to “10 pt.” Further, the CPU 202 calculates the points imparted to the sale processing of each of the products which are arranged between the product having the largest amount of carbon-dioxide emission 504 and the product having the smallest amount of carbon-dioxide emission 504 so that the imparted points approach “10 pt” as the amount of carbon-dioxide emission 504 thereof decreases. Then, an imparting unit 604 specifies the points calculated for a product being processed for sale from the points calculated for the respective products belonging to the same category as the product being processed for sale and imparts the specified points. Although this processing is described as being executed by the CPU 202, the present embodiment is not limited to this, and the processing may be executed by the CPU 302. Moreover, the points may be input at the store side rather than calculating the points.

In the present embodiment, although the store system 101 increments the points recorded on the point card as an incentive regarding environmental conservation corresponding to the amount of carbon-dioxide emission of a product, the present embodiment is not limited to this. For example, the store system 101 may perform a fund-raising activity for a large amount for a customer who purchased a product (eco-friendly product) of which the amount of carbon-dioxide emission is smaller as the incentive regarding environmental conservation corresponding to the amount of carbon-dioxide emission of the product.

According to the present embodiment, when a customer purchases an eco-friendlier product of which the amount of carbon-dioxide emission is small, the store system 101 imparts an incentive regarding environmental conservation to the customer, inducing the customer to purchase an eco-friendlier product. Thus, the amount of carbon-dioxide emission can be suppressed further, which can be utilized for carbon offsets.

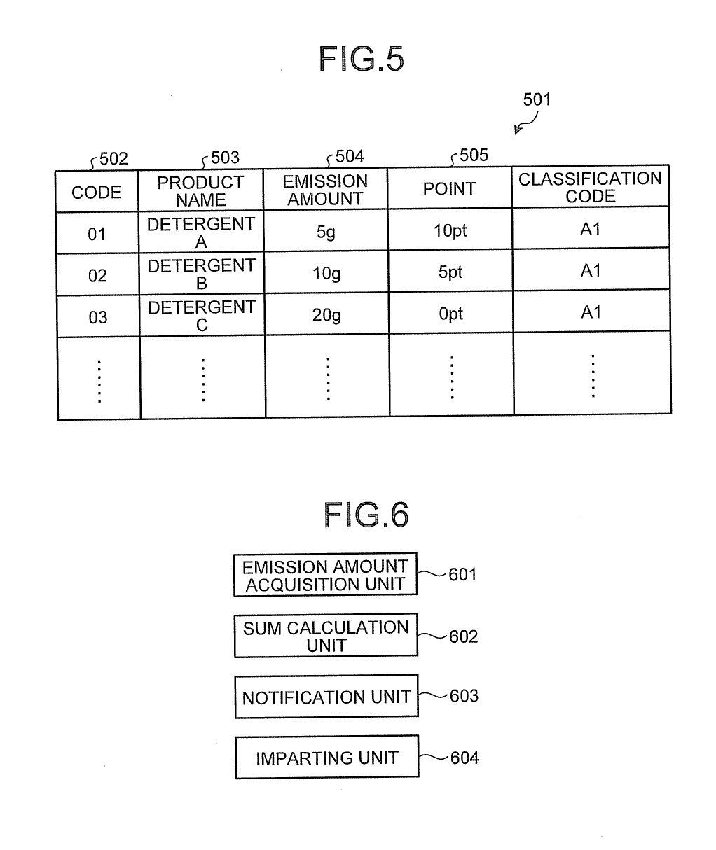

Next, among the processes that the microcomputer 201 executes using the OS and computer program installed in the HDD 208 of the store system 101, a characteristic process of the store system 101 according to the present embodiment will be described with reference to FIG. 6. FIG. 6 is a block diagram showing a module configuration of a store system according to the present embodiment.

The computer program executed by the store system 101 according to the present embodiment has a module configuration which includes the respective units shown in FIG. 6 (which are an emission amount acquisition unit 601, a sum calculation unit 602, a notification unit 603, the imparting unit 604, and the like). As actual hardware, the CPU 202 of the microcomputer 201 reads and executes the computer program from the HDD 208 to load the respective units onto the RAM 205, whereby the emission amount acquisition unit 601, the sum calculation unit 602, the notification unit 603, the imparting unit 604, and the like are generated on the RAM 205.

When sale processing is executed for a product, the emission amount acquisition unit 601 acquires the amount of carbon-dioxide emission 504 corresponding to the code 502 of the product processed for sale from the database 103. Moreover, in the present embodiment, the emission amount acquisition unit 601 reads product information, such as the product name 503, the point 505, and the unit price, corresponding to the code 502 of the product processed for sale from the database 103 through the headquarters system 102.

When sale processing is executed for plural products, the sum calculation unit 602 calculates the sum of the amounts of carbon-dioxide emission 504 of the products processed for sale acquired by the emission amount acquisition unit 601.

The notification unit 603 controls the printer 113 so as to print the amounts of carbon-dioxide emission 504 of the products processed for sale acquired by the emission amount acquisition unit 601 and the sum calculated by the sum calculation unit 602 on a receipt, thus raising the customer's level of consciousness regarding environmental conservation.

In the present embodiment, although the notification unit 603 provides notification of the amounts of carbon-dioxide emission 504 of the products processed for sale and the sum calculated by the sum calculation unit 602 by printing the amounts of carbon-dioxide emission 504 of the products processed for sale and the sum calculated by the sum calculation unit 602 on the receipt, the present embodiment is not limited to this. For example, the notification unit 603 may control the display controller 207 so as to display the amounts of carbon-dioxide emission 504 of the products processed for sale and the sum calculated by the sum calculation unit 602 on the liquid crystal display 111.

Moreover, the notification unit 603 may provide notification of the product information such as the amount of carbon-dioxide emission 504, the product name 503, and the unit price read by the emission amount acquisition unit 601 for each of the products processed for sale.

The imparting unit 604 controls the card rewrite terminal (not shown) so as to add the point 505 read by the emission amount acquisition unit 601 to the points recorded on the point card inserted in the card rewrite terminal. That is, in the present embodiment, the imparting unit 604 imparts the point 505 read by the emission amount acquisition unit 601 as an incentive regarding environmental conservation corresponding to the amount of carbon-dioxide emission of the product processed for sale.

In the present embodiment, although the imparting unit 604 adds the point 505 read by the emission amount acquisition unit 601 to the points recorded on the point card, the present embodiment is not limited to this. The CPU 202 may calculate the points corresponding to the amount of carbon-dioxide emission of the product processed for sale, and the imparting unit 604 may add the calculated points to the points recorded on the point card. For example, when sale processing is executed for an eco-friendlier product, the imparting unit 604 converts the point into higher points and adds the converted points to the points recorded on the point card.

In the present embodiment, although the imparting unit 604 imparts the points as described above, the present embodiment is not limited to this, and an activity may be performed for raising a fund corresponding to the amount of carbon-dioxide emission of the product processed for sale.

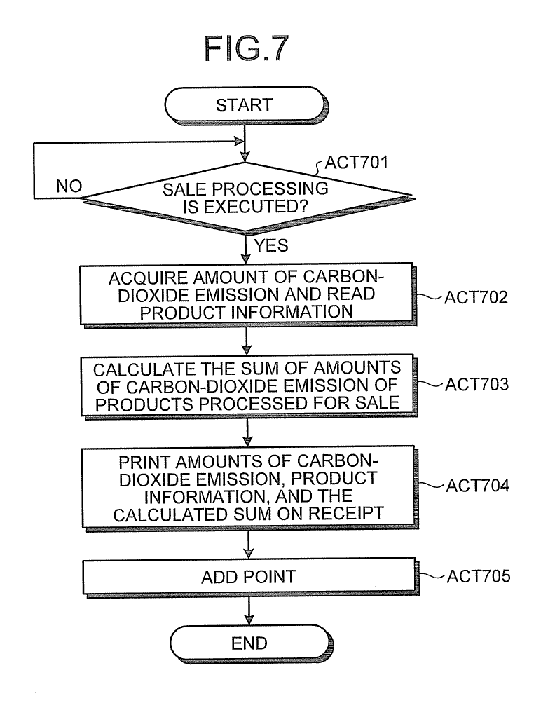

Next, the flow of a process of providing notification of the amount of carbon-dioxide emission of a product processed for sale will be described with reference to FIG. 7. FIG. 7 is a flowchart showing the flow of providing notification of the amount of carbon-dioxide emission of a product processed for sale.

The emission amount acquisition unit 601 waits for execution of sale processing (ACT 701: No). When sale processing is executed (ACT 701: Yes), the emission amount acquisition unit 601 acquires the amount of carbon-dioxide emission 504 corresponding to the code 502 of the product processed for sale and reads product information such as the product name 503 and the unit price, and the point 505 from the database 103 through the headquarters system 102 (ACT 702). Further, the sum calculation unit 602 calculates the sum of the amounts of the carbon-dioxide emission 504 of the respective products acquired by the emission amount acquisition unit 601 (ACT 703).

Subsequently, the notification unit 603 controls the printer 113 so as to print the amounts of carbon-dioxide emission 504 and the product information such as the product name 503 and the unit price of the products processed for sale acquired or read by the emission amount acquisition unit 601, and the sum calculated by the sum calculation unit 602 on a receipt (ACT 704). Further, the imparting unit 604 controls the card rewrite terminal (not shown) so as to add the points 505 read by the emission amount acquisition unit 601 altogether and then add the points to the points recorded on the point card inserted in the card rewrite terminal (ACT 705).

Although the computer program executed by the store system 101 of the present embodiment is provided in the form of being installed in the HDD 208, the computer program may be provided in the form of being incorporated in advance into a ROM or the like.

Moreover, the computer program executed by the store system 101 of the present embodiment may be provided in the form of an installable or executable file which is stored in a computer-readable recording medium such as a CD-ROM, a flexible disk (FD), a CD-R, and a DVD (Digital Versatile Disk).

Furthermore, the computer program executed by the store system 101 of the present embodiment may be provided in the form of being stored on a computer connected to a network such as the Internet and downloaded via the network. Moreover, the computer program executed by the store system 101 of the present embodiment may be provided or distributed via a network such as the Internet.

According to the POS system 1 according to the present embodiment, the POS system 1 includes the emission amount acquisition unit 601 that reads the amount of carbon-dioxide emission 504 corresponding to the code 502 of a product processed for sale from the database 103 through the headquarters system 102 when sale processing is executed for the product and the notification unit 603 that provides notification of the amount of carbon-dioxide emission 504 of the product processed for sale. Therefore, the retail stores are able to induce customers to participate in activities regarding environmental conservation for providing eco-friendlier products. Thus, it is possible to realize activities for suppressing the emission of carbon dioxides in the entire course of product distribution and contribute to environmental conservation.

Additional advantages and modifications will readily occur to those skilled in the art. Therefore, the embodiment in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A product sale processing apparatus comprising:
an emission amount acquisition unit that acquires the amount of carbon-dioxide emission over the entire course from the procurement of the raw materials of a product processed for sale to the disposal or recycling; and
a notification unit that provides notification of the carbon-dioxide emission amount acquired by the emission amount acquisition unit.

2. The apparatus according to claim 1, further comprising a sum calculation unit that calculates the sum of the amounts of carbon-dioxide emission of the products processed for sale,
wherein the notification unit provides notification of the amount of carbon-dioxide emission by printing the amounts of carbon-dioxide emission of the products processed for sale and the sum calculated by the sum calculation unit on a receipt.

3. The apparatus according to claim 1, further comprising an imparting unit that imparts an incentive regarding environmental conservation corresponding to the amount of carbon-dioxide emission acquired by the emission amount acquisition unit.

4. The apparatus according to claim 3, wherein the imparting unit imparts a point to be recorded on a point card possessed by a customer as the incentive regarding environmental conservation.

5. The apparatus according to claim 4, wherein the imparting unit imparts the point by adding a point corresponding to the amount of carbon-dioxide emission of the product processed for sale.

6. The apparatus according to claim 1, wherein the notification unit provides notification of the amount of carbon-dioxide emission acquired by the emission amount acquisition unit and product information of the product processed for sale for each product processed for sale.

7. A product sale processing method comprising:
acquiring the amount of carbon-dioxide emission over the entire course from the procurement of the raw materials of products processed for sale to the disposal or recycling; and
providing notification of the acquired carbon-dioxide emission amount.

8. The method according to claim 7, further comprising:
calculating the sum of the amounts of carbon-dioxide emission of the products processed for sale; and
providing notification of the amount of carbon-dioxide emission by printing the amounts of carbon-dioxide emission of the products processed for sale and the calculated sum on a receipt.

9. The method according to claim 7, further comprising imparting an incentive regarding environmental conservation corresponding to the acquired amount of carbon-dioxide emission.

10. The method according to claim 9, wherein a point to be recorded on a point card possessed by a customer is imparted as the incentive regarding environmental conservation.
